(19) United States
(12) Patent Application Publication
(10) Pub. No.: US 2020/0087944 A1
(43) Pub. Date: Mar. 19, 2020

(54) Support Poles

(71) Applicant: ECOPOLE AS, Bergen (NO)

(72) Inventor: Einar Stale Haveland, Fyllingsdalen (NO)

(21) Appl. No.: 16/688,679

(22) Filed: Nov. 19, 2019

Related U.S. Application Data
(62) Division of application No. 16/099,263, filed on Nov. 6, 2018.

(30) Foreign Application Priority Data
May 6, 2016 (GB) 1607925.3

(51) Int. Cl. E04H 12/04; E04C 3/36; E04H 12/02; B29C 44/12; B27J 1/00; B29C 44/60

(52) U.S. Cl. CPC E04H 12/04; E04C 3/36; E04H 12/02; B29K 2623/06; B27J 1/00; B29C 44/60; B29C 44/128

(57) ABSTRACT

A method of forming a support pole, comprising splitting one or more canes of bamboo, or similar tubular plant material, into a plurality of split lengths; inserting a bundle of the split lengths from one or more canes into an outer tube (4); tilting the outer tube (4) at an angle from horizontal and injecting a matrix material into the outer tube (4) so as to fill in between the split lengths and encapsulate the split lengths to form a substantially solid core. The method may comprise injecting the matrix material at multiple injection points (25a, 25b, 25c, 25d) along the length of the tube (4).

The present invention relates to methods of forming or manufacturing support poles and to support poles made by such methods. The support poles may particularly (but not exclusively) find use as utility poles for supporting overhead power lines, fibre transmission lines and various other public utilities, such as cables and related equipment (transformers, street lights, etc.).

Utility poles, also known as telephone poles, power poles, hydro poles (e.g. in Canada), telegraph poles or telegraph posts, are conventionally made of solid timber. There have also been proposals for utility poles made of metal, concrete, or composites like fibreglass. Utility poles are typically are used for low and medium voltage power transmission. As the poles are usually spaced relatively close together in a power transmission network, a huge number of poles is needed and they must allow for ease of installation and maintenance.

Conventional timber poles are vulnerable to attack by pests such as termites, rodents and woodpeckers. The lifetime of timber poles is usually extended by treating them with creosote as a pesticide. However such treatment adds to maintenance costs. Moreover the environmental impact of creosote-treated timber has been called into question, especially the potential pollution of ground water. Treated wooden poles can last for 15-20 years before requiring replacement, but in developing countries such as Africa timber poles are typically left untreated and then only last for less than 10 years. A further problem with using timber for utility poles is its contribution to global deforestation.

Alternative pole materials also have a range of drawbacks. Concrete poles require internal steel reinforcement for strength but the steel component is vulnerable to corrosion while the concrete often degrades quite rapidly, especially if poor quality cement is used. The poles are prone to cracking and brittle fracture. Concrete poles are also very heavy for handling and installation purposes. Cranes or other types of lifting equipment are required for installation. The costs involved in producing and installing concrete poles are higher than for timber poles. The lifetime of a concrete utility pole is typically 15-20 years. The cost of fibre-reinforced plastic poles is prohibitive for most purposes. In both cases, materials recycling after use is not easy.

The costs involved in materials and in manufacturing, transporting, installing and maintaining the poles in a power transmission network may be of particular concern in developing countries, for example in Africa and Asia. Furthermore the environmental impact of building the infrastructure in such countries is now a serious factor to be taken into consideration.

NO 20072814 describes a pole made from whole bamboo canes arranged inside an outer tube of plastic with the gaps between bamboo canes partially filled with a rigid matrix material. It is disclosed that such poles have a long lifetime and can be recycled. However, an important consideration in the design of utility poles is the strength requirement. By way of comparison, concrete poles can withstand working loads of at least 2.5 kN. A potential problem with the poles seen in NO 20072814 is that the matrix material may not fill the gaps between bamboo canes very well and leave voids i.e. air pockets that affect strength properties.

WO 2014/001811 describes a method of manufacturing poles by cutting openings into the side walls of whole bamboo canes so as to enable the intermodal cavities of the bamboo to be filled with a binder material. This was found to provide a strength improvement as compared to hollow bamboo canes encapsulated in a matrix material. However, the strength and reproducibility of such an “intermodal locking” arrangement may depend on the ability of the manufacturing process to reliably fill in and around the bamboo canes with the binder material.

There remains a need for improved methods of manufacturing support poles that can provide the poles with reliable strength as well as environmental benefits.

According to a first aspect of the present invention there is provided a method of forming a support pole, comprising:

splitting one or more canes of bamboo, or similar tubular plant material, into a plurality of split lengths;

inserting a bundle of the split lengths from one or more canes into an outer tube; and

tilting the outer tube at an angle from horizontal and injecting a matrix material into the outer tube so as to fill in between the split lengths and encapsulate the split lengths to form a substantially solid core.

It has been found that forming a substantially solid core from split lengths of bamboo (or similar tubular plant material) in an encapsulation matrix makes it possible to increase the bamboo fibre content and ensures an even distribution both through the cross-section of the pole and around the perimeter of the pole. As compared to a pole containing whole bamboo canes as reinforcement of a matrix, the pole strength is increased in all directions and poles can be manufactured with better consistency and repeatability. Furthermore, tilting the outer tube at an angle while injecting the matrix material has been found to avoid air pockets or voids forming inside the outer tube, that might otherwise interrupt the substantially solid core. This increases the material density of the core and contributes to the strength of the resultant pole. There is no risk of internal collapse when a pole has been made by such methods. Poles made according to the method of the present invention have been found to elastically deflect over a much larger range and withstand much larger loads, i.e. achieving a higher ultimate load then previously known. Furthermore, such methods are more reliable and enable poles to be mass produced with consistent strength properties.

Bamboo-based poles provide many benefits over conventional timber or concrete utility poles. Bamboo is a very fast growing material and its production does not contribute to deforestation. Bamboo has a unique strength to weight ratio compared to soft wood. Using a matrix material to fill in and around the split lengths, together with an outer tube, protects the bamboo from pest damage or environmental degradation. Toxic treatment e.g. creosote is not required. The poles are expected to have a lifetime of at least 50 years, i.e. much longer than standard utility poles. The manufacturing process does not generate CO₂ emissions, as does the production of cement; rather bamboo collects CO₂ while growing and the opportunity for local bamboo farming can reduce the carbon footprint involved in production. Furthermore the poles are recyclable after use.

The Applicant has found that tilting the outer tube at any angle from horizontal can assist the matrix material in encapsulating the split lengths to form a substantially solid core. Preferably the outer tube is tilted at an angle of at least 3°, 4°, 5° or 6°. However it is preferable not to tilt the outer tube too far. For example, this may require a more complicated support arrangement and/or cause gravity to have too much of an effect on the injection process. In a preferred set of embodiments the outer tube is tilted at an angle of 5-6°. Such angles have been found optimal to aid in the release of air from the outer tube during injection of the matrix material.

The Applicant has observed that a problem with injecting a matrix material around split lengths of bamboo is that the surface friction properties of bamboo tend to interrupt the flow or expansion of the matrix material. It can therefore be difficult to form a substantially solid core inside the outer tube without any voids or air pockets.

The matrix material is preferably injected in the presence of a vacuum. This may assist in evacuating air from inside the outer tube as it is filled with the matrix material. A vacuum may be applied at any suitable point along the length of the outer tube. However, in a preferred set of embodiments the method comprises applying a vacuum at a high point along the tilted tube. For example, a vacuum application port may be provided close to an upper end of the tilter outer tube. This provides for optimal evacuation as air bubbles are released upwardly.

The step of injecting matrix material into the outer tube may comprise any process suitable for the matrix material chosen. The matrix material may be injected into the outer tube at a single location, or at multiple locations, e.g. to make the filling process as quick and/or effective as possible. Thus the method may further comprise injecting the matrix material through one or more openings in a side wall of the outer tube. Such openings may be arranged substantially in a line along the length of the outer tube, for example to align with a row of injection nozzles. Alternatively, or in addition, such openings may be arranged at one or more different circumferential positions around the outer tube. Regardless of the position of the openings, the method may further comprise sealing the one or more openings after injecting the matrix material.

The injecting step may be carried out at a relatively low pressure, for example slightly above atmospheric pressure, e.g. around 2-5 bar. While the matrix material itself may be at an elevated pressure as it is injected into the outer tube, for example due to the expansion of a foam material formed by mixing precursors during injection, it has been found that the pressure inside the outer tube quickly equalizes in the presence of a vacuum. The matrix material may only be able to spread along the tube a certain distance from the point of injection. The Applicant has addressed this by devising a novel injection procedure.

In a preferred set of embodiments, injecting the matrix material into the tilted outer tube comprising injecting the matrix material at multiple injections points along the length of the tube. Preferably the multiple injections points comprise a first injection point that is lower than subsequent injection points along the tilted outer tube. The first inspection point may be relatively close to a lower end of the tilted outer tube, for example 10, 20, 30, 40 or 50 cm from the lower end of the tilted tube. The one or more subsequent injection points may be spaced at any suitable distance along the tilted tube from the first injection point. Of course this spacing may depend on factors such as the tube diameter and/or choice of matrix material. Ambient conditions, e.g. altitude, may also have an effect on how the matrix material fills in between the split lengths and encapsulate the split lengths to form the solid core. In some embodiments, the one or more subsequent injection points may be spaced at about 250 cm intervals along the outer tube. The number of injection points will depend on the length of the outer tube, for example a 10 m long pole may require four injection points along the outer tube. Preferably the final injection point is higher than all the other injection points, i.e. close to an upper end of the tilted outer tube. Further preferably a vacuum is applied at another point that is even higher than the final injection point. This means that the vacuum can suck air out of the tube the whole time that it is being filled up with the matrix material.

It will be appreciated that each injection point may comprise one or more openings formed in a side wall of the outer tube. In one set of embodiments, the openings that form the injection points may be preformed in the outer tube before inserting a bundle of the split bamboo lengths. In another of embodiments, the openings that form the injection points may be formed in the outer tube after inserting a bundle of the split bamboo lengths.

It has been found that following the injection procedures described above can result in a support pole that has a better fill density of matrix material. The tilting of the outer tube, preferably in combination with application of a vacuum and/or multiple injection points, enables the matrix material to better fill in between the split lengths and encapsulate the split lengths to form a substantially solid core with substantially no voids or air pockets. Thus according to preferred embodiments the method comprises injecting the matrix material into the outer tube so as to fill in between the split lengths and encapsulate the split lengths to form a substantially solid core containing no voids. The use of multiple split lengths, rather than whole canes of bamboo, prevents the problem of voids being formed where the outer surfaces of whole canes rest against the internal surfaces of the outer tube and hinder the flow of matrix material. By avoiding the risk of formation of voids entirely, the methods described herein can ensure that consistent strength properties are achieved for every pole.

In order to help contain the solid core, especially during injection of the final amount of matrix material at the final injection point, the method may further comprise closing one or both ends of the outer tube with an end cap before injecting the matrix material. Preferably at least the upper end of the tilted tube is closed with an end cap. It has been appreciated that a convex end cap is particularly advantageous for withstanding any elevated pressure inside the outer tube and also acts to avoid deformation of the pole after the solid core has been formed, for example if the pole is loaded in tension and tends to bend.

This is considered novel and inventive in its own right, and thus when viewed from a second aspect the present invention provides a method of forming a support pole, comprising:

splitting one or more canes of bamboo, or similar tubular plant material, into a plurality of split lengths;

arranging a bundle of the split lengths from one or more canes inside an outer tube; and

closing at least one end of the outer tube with a convex end cap and injecting a matrix material into the outer tube so as to fill in between the split lengths and encapsulate the split lengths to form a substantially solid core.

Using such a convex end cap to seal at least one end of the outer tube, the internal mass of the substantially solid core cannot be displaced and this contributes to increased pole strength and performance when the pole is loaded, especially during bending. In particular, the flexural strength of the pole may be improved. It is flexural strength that allows a pole to withstand high winds and external vibrations, for example, during use. Preferably both ends of the outer tube are closed with a convex end cap.

In embodiments of this second aspect of the invention, the at least one end of the outer tube that is closed by a convex end cap is preferably positioned at an upper end when the outer tube is tilted at an angle from horizontal before injecting the matrix material. The injecting step may have any of the features already described hereinabove.

The one or more end caps may be attached to the outer tube by any suitable joining technique, e.g. adhesive or ultrasonic welding. In a preferred set of embodiments the method comprises butt welding each convex end cap onto an end of the outer tube. Butt welding enables the end caps to be attached without an overlap. Preferably the outer tube has a substantially constant outer diameter along its length and the end caps have the same outer diameter. It has been found that a butt welded joint can be as strong as, if not stronger than, the outer tube itself e.g. a polyethylene tube.

The present invention extends to a support pole comprising an outer tube and a substantially solid core that comprises a plurality of split lengths of one or more canes of bamboo, or similar tubular plant material, encapsulated by a matrix material inside the outer tube. Preferably one or both ends of the outer tube is closed by a convex end cap. In other words, the present invention extends to a support pole comprising an outer tube closed at both ends by a convex end cap and a substantially solid core that fills the outer tube between the end caps, the core comprising a plurality of split lengths of one or more canes of bamboo, or similar tubular plant material, encapsulated by a matrix material. Preferably the one or more end caps are butt welded onto the ends of the outer tube.

In embodiments according to any aspect of the invention, the matrix material can act to protect the split lengths from moisture and prevent degradation of the bamboo. The matrix material may also contribute to the lightweight properties of poles made according to the present invention. The matrix material may be any rigid or semi-rigid material that can be injected (e.g. in molten or liquid form). Examples may include plastics, rubber, cement, ceramic, metal foam, etc. A polymeric matrix material may be preferred for its low density. However at least some plastics may not bind very well to the bamboo stems. A synthetic polymer foam, such as polyurethane (PUR) foam, has been found to bind well to the split lengths of bamboo. In preferred embodiments the matrix material therefore consists of a polyurethane foam. PUR foam has demonstrated good mechanical properties as well as being lightweight, non-toxic and non-flammable. An advantage of using PUR foam (or similar) is that it may be formed by mixing liquid precursors (e.g. isocynate and polyol) that react in situ to create a foam that expands to fill the outer tube. The injecting step may therefore comprise injecting at least two precursor materials that react to form the matrix material in situ. For polyurethane, this step may comprise injecting polyol and polyisocyanate in liquid form, in the presence of water, to produce an exothermic reaction forming the polyurethane foam.

A polymeric matrix material, in particular an elastomeric material (such as PUR foam) may further be beneficial as it can provide the poles with a unique flexural strength as compared to more rigid matrix materials. As mentioned above, flexural strength allows a pole to withstand high winds and external vibrations. Using a polymeric matrix material the poles are capable of absorbing significantly more elastic energy than conventional materials such as steel or concrete. The poles will flex back to their original configuration after loading. Some elastomeric materials, such as natural or synthetic rubber, may make the support poles too flexible. Polyurethane foam has been found to provide a good balance between resilience and stiffness, i.e. between rigid and flexible properties. Such poles can bend under loads without the PUR matrix material breaking.

It has been found that poles made according to methods of the present invention are more resilient and can survive rough handling e.g. during transport and/or installation. A drop test for the examination of the rough handling properties of a composite pole is described in Kenya Standard KS 2513:2014. In this test, a pole is dropped horizontally from a height of 3 m above ground level and onto a rigid straight concrete surface. After drop, the pole is inspected for any visible cracks around its total circumference. Poles made according to methods of the present invention have been found to survive such a drop test without any damage occurring, whereas conventional fibre glass composite poles become cracked.

Preferably the method further comprises inspecting how the matrix material fills in between the split lengths in the outer tube using infrared radiation emitted from the core. The Applicant has appreciated that infrared imaging may provide a particularly convenient way to monitor the injection process and/or provide for quality inspection of the solid core. This is considered novel and inventive in its own right, and thus when viewed from a further aspect the present invention provides a method of forming a support pole, comprising:

splitting one or more canes of bamboo, or similar tubular plant material, into a plurality of split lengths;

arranging a bundle of the split lengths from one or more canes inside an outer tube; injecting a matrix material into the outer tube so as to fill in between the split lengths and encapsulate the split lengths to form a substantially solid core; and

inspecting how the matrix material fills in between the split lengths in the outer tube using infrared radiation emitted from the core.

The inspecting step may take place during and/or after injecting the matrix material into the outer tube. Accordingly such inspection can be used to monitor the progress of the injection procedure and/or to monitor one or more physical parameters of the solid core so formed. For quality control purposes, the method preferably comprises inspecting the solid core using infrared radiation following complete injection of the matrix material, further preferably while the solid core is still at an elevated temperature. For example, the inspection may take place up to about 10 s after complete injection. Such integration of the inspection and injection procedures takes advantage of the fact that the still-warm matrix material can provide for strong contrast in an infrared image. This means that an operator can easily see from the infrared image whether the outer tube has been completely filled with the matrix material occupying all available space between the split lengths. In a preferred set of embodiments, inspecting the solid core comprises determining the percentage by volume (if any) of any voids in the solid core. For example, infrared images may be assessed during the inspection step, or at a later stage, to determine the presence or absence of any voids. The determined percentage by volume may be used for quality control and/or to categorise the resulting poles.

Inspection with infrared radiation may comprise using an infrared camera. Such a camera may be moved along the tube automatically or manually so as to build up an image of the entire solid core. The infrared images produced by the camera may be inspected visually by an operator and/or analysed by appropriate software. In practice, it may not be necessary to inspect every pole that is produced by a given manufacturing unit. The inspection step may only be applied to selected poles as a matter of quality control. Those poles which are inspected and found to be sub-optimal may be rejected. It is advantageous for such inspection to take place regularly. The identification of unsatisfatory filling, for example a higher percentage by volume of voids than is desirable, could be used to diagnose problems with the injection process. Thus the inspection step may provide feedback for controlling the injection step.

The step of splitting one or more canes of bamboo, or similar tubular plant material, into a plurality of split lengths is preferably performed after limbing and washing of the harvested bamboo canes. Depending on the bamboo cane diameter, the cane may split into 4-6 individual split lengths. Splitting can be performed manually (e.g. using a machete) or using a splitting machine. The Applicant has found that it can be important for the split lengths of bamboo to have a relatively lower moisture content before they are bundled up to make a support pole. Preferably the initial step of splitting one or more canes of bamboo further comprises separating the split lengths and supporting them while air drying. The split lengths may be supported in a horizontal or vertical position for air drying.

The split lengths may be bundled up without any further treatment. However, in at least some embodiments it is preferable that splitting the one or more canes of bamboo further comprises removing any internal nodes from the split lengths. This can make it easier for the split lengths to lie side by side and be arranged in a tight bundle without any substantial gaps between adjacent split lengths.

After drying, the split lengths are then bundled together. The outside diameter of the bundle is chosen to match the size of the outer tube, for example 220 mm. The steps involved in forming a bundle are generally as previously described in WO2014/001811, however using split lengths rather than whole bamboo canes. Accordingly any of the methods described above may further comprise one or more of the following steps:
arranging a plurality of split lengths from one or more canes in a longitudinally parallel arrangement, using one or more jigs or fixtures, to form a bundle;
tightening the one or more jigs or fixtures around the split lengths to form the bundle;
fastening the longitudinally parallel arrangement (for example, tying a rope or band around the outside of the longitudinally parallel arrangement) and removing the one or more jigs or fixtures before inserting the bundle into the outer tube.

However the Applicant has appreciated that the bundling procedure can be improved when using split lengths rather than whole canes of bamboo. In particular, it is possible to vary the density of bamboo material along the length of the bundle and hence along the length of the resultant support pole. This can be achieve by bundling together split lengths at least some of which are shorter than the length of the outer tube and bundling more split lengths into the same cross-sectional area in one region of the bundle than others. For an outer tube of length 8-10 m, for example, the split lengths may have a range of lengths from 4 m upwards. The Applicant has recognised that it can be beneficial for the support pole to contain a higher density of bamboo material at one end as compared to the other end, with this end being the bottom end (e.g. inserted into the ground) when the support pole is installed in a vertical orientation. Accordingly any of the methods described above may further comprise arranging a plurality of split lengths having different lengths in a longitudinally parallel arrangement to form a bundle having a greater number of split lengths at one end than the other end.

The outer tube is preferably formed of a polymeric material, e.g. polyethylene. The outer tube can protect against the ingress of water and humidity, ensure that the pole can withstand rough handling, and protect from UV damage. The outer tube determines the final outer diameter of the support pole and therefore using different tubes easily enables manufacture of a range of different diameter poles. This is an advantage over conventional timber poles, where the diameter may be limited by the size of trees used. Preferably the outer tube has a substantially constant outer diameter along its length. This means that the pole advantageously has an outer diameter that is uniform along its length. Any convex end caps used to close one or more ends of the outer tube are preferably made of the same material as the tube, e.g. polyethylene.

Advantageously, support poles made according to methods of the present invention have been found to have a very low weight per unit length, preferably a weight per unit length less than 25 kg/m and further preferably even less than 10 kg/m, for example only 7-8 kg/m. By way of comparison, a standard concrete pole typically has a weight per unit length of around 100 kg/m, i.e. five times heavier. Support poles made according to methods of the present invention may therefore provide the same load capacity as standard concrete poles, but they can be more than 80% lighter in weight. Support poles made from stems of bamboo can also be more than 50% lighter than standard timber poles. This makes them easier to handle, reduces transport and installation costs, and reduces the associated carbon footprint.

Advantageously, support poles made according to methods of the present invention have been found to have good flexural strength properties. When the poles are tested using a cantilever test method, for example as described in Kenya Standard KS 2513:2014, they have been found to deflect elastically under load and then return to a straight pole once the load is removed. The ultimate load that can be achieved is higher than for poles made using prior art methods. Even when a pole is loaded beyond its ultimate strength, it is found to be weakened but continues to bend gradually rather than snapping. This makes the poles safer to handle than more brittle poles e.g. made from wood or glass fibre composite. It will be appreciated that the ultimate load which can be carried by a given pole depends on its diameter and length, with bigger poles being stronger. Generally the required flexural strength or ultimate load required of a pole will be dictated by the intended installation, for example taking into account various factors such as the number of power lines to be carried by the pole, whether the power lines are high or low voltage, height of the power lines above the ground, and environmental factors (exposure to high winds, snow, etc.). The diameter and/or length of a pole may therefore be selected so as to achieve the required strength properties.

As is described above, a support pole made according to methods of the present invention may comprise a greater density of bamboo, or similar tubular plant material, at one end than the other end. The bottom end of the support pole, when standing vertically in use, may have the greater density of bamboo material.

It is advantageous that a support pole made according to methods of the present invention may contain substantially no voids in the solid core as compared to a support pole made from whole canes of bamboo. In preferred embodiments the substantially solid core may comprise at least 20% by volume of split lengths and 80% or less by volume of matrix material. In the solid core the split lengths are completely surrounded by and embedded in the matrix material.

As is described above, the matrix material preferably comprises a polyurethane foam.

Support poles may be made according to methods of the present invention to have a range of lengths and/or outer diameters. For example, in some embodiments the support poles may have a length of 8 m, 9 m or 10 m. In some embodiments the support poles may have am outer diameter of 180 mm, 200 mm, or 225 mm. The weight per unit length may therefore depend on the diameter of the pole. Such support poles may be characterised by having a relatively low density, as compared to traditional timber or concrete poles. Preferably support poles made according to methods of the present invention have a density between 300 kg/m³ and 600 kg/m³.

Bamboo is a tubular plant material (naturally hollow inside) that belongs to the grass family Poaceae. There are more than 1,000 different bamboo species and nearly a hundred different kinds. Of these, Tonkin cane (Arundinaria amabilis or Pseudosasa amabilis) may be preferred. However it is an advantage of the present invention that support poles can be made from locally available materials, with a reduced carbon footprint as compared to conventional poles, and so the choice of bamboo species may be based on local availability.

Poles made according to the present invention may find use not only as utility poles (e.g. power or telegraph poles), but also as fence poles, poles used in growing fruit and berries, and as naval poles for docks, marinas, quays, etc.

Some preferred embodiments of the present invention will now be described, by way of example only, and with reference to the accompanying drawings, in which:

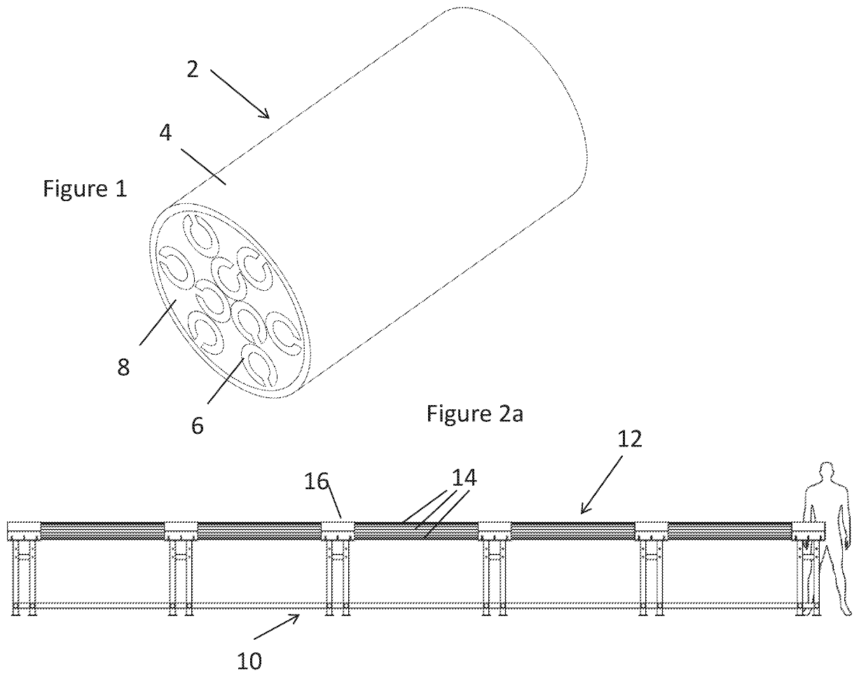

FIG. 1 shows a support pole made from whole canes of bamboo encapsulated in a matrix material as described in WO 2014/001811;

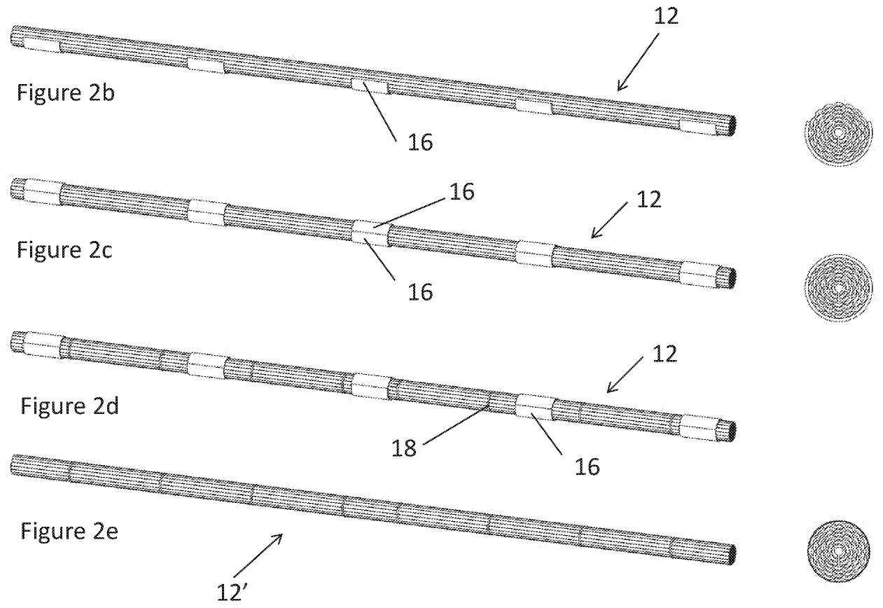

FIGS. 2a-2e show the steps involved in forming a bundle of bamboo split lengths according to embodiments of the present invention;

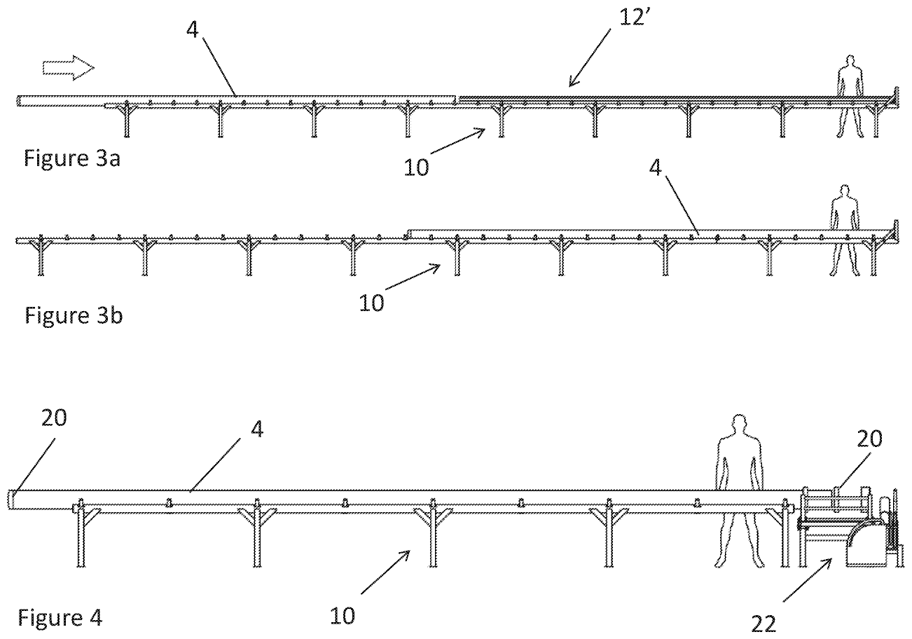

FIGS. 3a-3b show the steps involved in inserting a bundle of split lengths into an outer tube according to embodiments of the present invention;

FIG. 4 shows the attachment of end caps to the outer tube according to embodiments of the present invention;

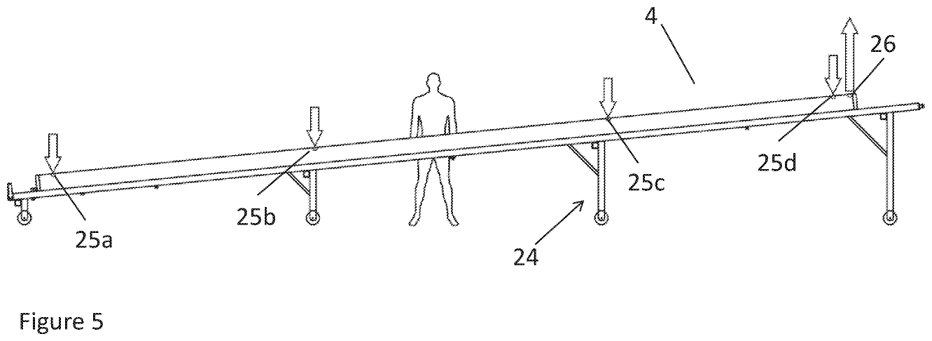

FIG. 5 shows filling of a tilted outer tube according to embodiments of the present invention;

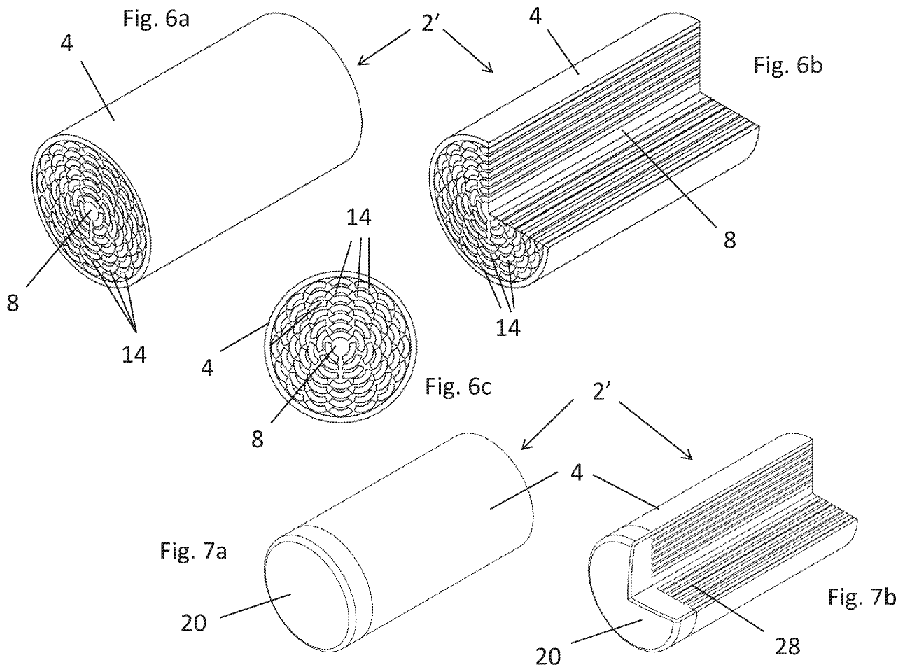

FIGS. 6a-6c show the structure of a support pole made according to embodiments of the present invention;

FIGS. 7a-7b show a support pole closed by end caps according to embodiments of the present invention; and

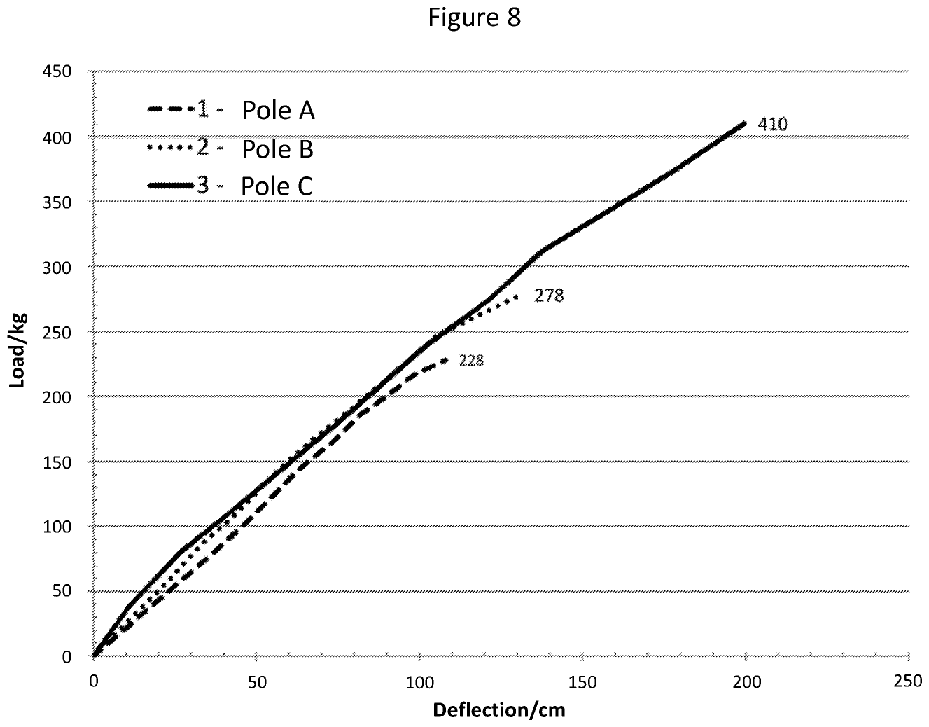

FIG. 8 shows some cantilever test results for support poles made according to different manufacturing techniques.

There is seen in FIG. 1 a cross-sectional view of a support pole made according to the methods described in WO 2014/001811. The support pole 2 comprises an outer tube 4, for example a polyethylene (e.g. HDPE) tube, that contains a core volume comprising substantially whole canes or stems of bamboo 6 encapsulated in a matrix material 8 such as PUR foam. Prior to filling the outer tube, the bamboo canes 6 have longitudinal slots cut into their side walls so that the matrix material 8 is able to access the internodal cavities of each cane. However, the Applicant has found that the ability of the matrix material 8 to fill the internodal cavities is in practice very sensitive to multiple factors and it can be difficult to ensure that support poles made in this way have a uniform density, both along the length of a given pole and when comparing multiple poles in a manufacturing batch. Accordingly it is now proposed to make support poles using split lengths of bamboo material instead, as will be described with reference to FIGS. 2-7.

The initial steps for preparation of a bundle of split lengths of bamboo include harvesting, limbing, cleaning, splitting, drying and then bundling. Depending on the bamboo cane diameter, each cane or stem is split into 4-6 individual splits. Splitting can be performed manually (e.g. using a machete) or by a splitting machine. After the split lengths have been air dried they are ready to be bundled. FIG. 2a shows a stand 10 used to form a bundle 12 of split lengths 14. The stand 10 supports a number of jigs 16. In a first step, seen in FIG. 2b, the jigs 16 are open and the split lengths 14 are arranged into a bundle (i.e. longitudinal parallel arrangement). In a second step, seen in FIG. 2c, the jigs 16 are closed around the bundle 12. In a third step, seen in FIG. 2d, ropes 18 are fastened around the bundle 12 and tightened. In a fourth step, seen in FIG. 2e, the final bundle 12′ is removed from the jigs 16.

The tight bundle 12′ is then ready to be inserted into an outer tube 4, as is shown by FIGS. 3a and 3b. FIG. 3a shows the bundle 12′ supported by a stand 10 while an outer tube 4 is slid around the bundle 12′. FIG. 3b shows the outer tube 4 containing the bundle of split stems. FIG. 4 illustrates how a convex end cap 20 is attached to one or both ends of the outer tube 4. A butt welding machine 22 may be used for fusion of the end caps 20, for example a butt fusion machine version TM 250 or 315 available from Georg Fischer (GF) Piping Systems. The convex end caps 20 ensure that the bundle 12′ of bamboo splits is contained in the outer tube 4 and, more importantly, after the outer tube 4 has been filled to form a solid core the resultant pole is resistant to deflections. The convex end caps 20 may be made of the same material as the outer tube 4, e.g. polyethylene.

FIG. 5 shows a tilted stand 24 used to support the outer tube 4 during the filling process. Multiple openings 25a-25d are spaced along the length of the outer tube 4 to act as injection points for the matrix material. Each injection point is designated by a downwards arrow. The stand 24 supports the outer tube 4 at an angle from horizontal, tilted at approximately 6±0.5°. The matrix material is injected into the tube 4 starting at the lowermost injection point 25a, then moving upwards along the tube 4 to the injection points 25b, 25c, 25d. Throughout the injection process, a vacuum (designated by an upwards arrow) is applied at a final opening 26 which is positioned above the final injection point 25d close to one end of the tube 4.

Although not shown in FIG. 5, during and/or after the injection process an infrared camera may be moved along the outer tube 4 to provide an image of the solid core being formed inside the tube 4. The infrared images can be used to inspect how well the matrix material is filling between the bamboo splits.

FIG. 6 shows the internal structure of the resultant support pole 2′. Inside the outer tube 4, there is formed a solid core containing bamboo splits 14 encapsulated in the matrix material 8. FIG. 6a provides an overview of the pole 2′. FIG. 6b provides a cutaway view of the pole 2′, showing how the bamboo splits 14 are in a longitudinal parallel arrangement with the matrix material 8 completely filling the gaps between the splits 14. FIG. 6c provides a cross-sectional view showing the uniform distribution of bamboo splits 14 and complete encapsulation by the matrix material 8 without any voids (e.g. air pockets) being present.

FIG. 7 shows the external structure of the resultant support pole 2′. The outer tube 4 is closed at one or both ends by a convex end cap 20. FIG. 7a provides an overview of the pole 2′. FIG. 7b provides a cutaway view of the pole 2′, showing how the end cap 20 has a curved surface that is slightly convex away from the solid core 28 inside the tube 4. The solid core 28 is made up of the bamboo splits 14 and matrix material 8 as seen in FIGS. 6a-6c. It has been found that such convex end caps 20 advantageously help the pole 2′ to resist deformation when subjected to bending forces.

### EXAMPLE

Various support poles made of bamboo material in a polyurethane matrix with a surrounding outer tube were tested and compared. The materials used were the same, but the poles were formed using different techniques. Pole A (diameter 225 mm; length 9 m) was made from whole hollow stems of bamboo. Pole B (diameter 225 mm; length 9 m) was made from whole stems of bamboo that were slit open as seen in FIG. 1. Pole C (diameter 225 mm; length 10 m) was made from split lengths of bamboo as described above with reference to FIGS. 2-7. The cantilever test method described in Kenya Standard KS 2513:2014 was used to load the poles. The results of this test are seen in FIG. 8. It can be seen from the gradient of load vs. deflection that Pole C was similar to Poles A and B in terms of rigidity, but the maximum or ultimate load achieved with Pole C was much higher (referring to the load figures at the end of each line on the graph). Pole C achieved an ultimate load of 410 kg which was much greater than the ultimate load of 278 kg for Pole B and 228 kg for Pole A. In other words, Pole C was observed to bend elastically over a much greater range of deflection before reaching its ultimate load and hence Pole C is significantly improved in terms of bending strength. Pole C demonstrates the improved properties achieved using methods according to embodiments of the present invention.

It will be appreciated that various changes or modifications may be made to the embodiments described above. For example, the pole does not need to have a circular cross-section and could instead be made in a rectangular or other form. Other reinforcing material(s) might optionally be embedded in the matrix material inside the pole, in addition to the split lengths of bamboo, for example natural or synthetic fibres, metal rods, wires, grids, etc. and/or plastic or ceramic fibres, rods, particles, etc.

Poles made according to embodiments of the present invention may be used to support loads in a variety of applications, including utility poles (e.g. power or telegraph poles), and also finding use as fence poles, poles used in growing fruit and berries, and as naval poles for docks, marinas, quays, etc.

What is claimed is:

1. A method of forming a support pole, comprising:
splitting one or more canes of bamboo, or similar tubular plant material, into a plurality of split lengths;
inserting a bundle of the split lengths from one or more canes into an outer tube; and
tilting the outer tube at an angle from horizontal and injecting a matrix material into the outer tube so as to fill in between the split lengths and encapsulate the split lengths to form a substantially solid core.

2. The method according to claim 1, further comprising applying a vacuum at a high point along the tilted tube.

3. The method according to claim 1, comprising injecting the matrix material at multiple injections points along the length of the tube, wherein the multiple injections points comprise a first injection point that is lower than subsequent injection points along the tilted outer tube.

4. The method according to claim 3, wherein the multiple injections points comprise a final injection point that is higher than all the other injection points, the method further comprising applying a vacuum at another point that is even higher than the final injection point.

5. The method according to claim 1, further comprising closing at least an upper end of the outer tube with a convex end cap before injecting the matrix material into the tilted outer tube.

6. A method of forming a support pole, comprising:
splitting one or more canes of bamboo, or similar tubular plant material, into a plurality of split lengths;
arranging a bundle of the split lengths from one or more canes inside an outer tube; and
closing at least one end of the outer tube with a convex end cap and injecting a matrix material into the outer tube so as to fill in between the split lengths and encapsulate the split lengths to form a substantially solid core.

7. The method according to claim 6, comprising butt welding each convex end cap onto an end of the outer tube.

8. The method according to claim 1, comprising injecting a polyurethane foam as the matrix material.

9. The method according to claim 1, comprising injecting the matrix material into the outer tube so as to fill in between the split lengths and encapsulate the split lengths to form a solid core containing substantially no voids.

10. The method according to claim 1, further comprising inspecting how the matrix material fills in between the split lengths in the outer tube using infrared radiation emitted from the core.

11-15. (canceled)

16. The method according to claim 1, further comprising arranging a plurality of split lengths having different lengths in a longitudinally parallel arrangement to form a bundle having a greater number of split lengths at one end than the other end.

17. The method according to claim 1, wherein splitting one or more canes of bamboo further comprises separating the split lengths and supporting them while air drying.

18. The method according to claim 1, wherein splitting one or more canes of bamboo further comprises removing any internal nodes from the split lengths.

19. A support pole made according to the method of claim 1.

20. A support pole comprising an outer tube and a substantially solid core that comprises a plurality of split lengths of one or more canes of bamboo, or similar tubular plant material, encapsulated by a matrix material inside the outer tube,
Wherein one or both ends of the outer tube is closed by a convex end cap.

21-24. (canceled)

25. The support pole according to claim 20, comprising a greater density of bamboo, or similar tubular plant material, at one end than the other end.

26. The support pole according to claim 20, wherein the substantially solid core comprises at least 20% by volume of split lengths.

27. (canceled)

28. The support pole according to claim 20, wherein the pole has a weight per unit length less than 25 kg/m.

29. The support pole according to claim 20, wherein the pole has a density between 300 kg/m³ and 600 kg/m³.

30. The support pole according to claim 20, consisting of a utility pole.
